(19) United States
(12) Patent Application Publication
(10) Pub. No.: US 2002/0182288 A1
(43) Pub. Date: Dec. 5, 2002

(54) Method of producing confectionery products from brown rice

(76) Inventors: Taketo Kanehiro, Hikari-Shi (JP); Toshimitsu Kitamura, Tokuyama-Shi (JP); Cho Oyama, Yamaguchi-Ken (JP)

Correspondence Address: WILLIAM J. DANIEL, 6100 WOODLAND TERRACE, MCLEAN, VA, 22101-4225, US

(21) Appl. No.: 10/093,612

(22) Filed: Mar. 11, 2002

(30) Foreign Application Priority Data
Mar. 13, 2001 (JP) 2001-117473

(51) Int. Cl. A23K 1/00

(52) U.S. Cl. 426/49

(57) ABSTRACT

Confectionery products are made from brown rice by germinating steam-cooked brown rice and then making the same, optionally with up to 90% by wt of steam-cooked white rice and/or polished wheat, into koji by the usual procedure for making koji by inoculation with the mold Aspergillus oryzae; subjecting the koji, optionally with a minor amount of maltose, to a primary fermentation in the presence of an enzyme mixture comprising enzymes capable of decomposing the starch, protein, and lipids therein to yield a substantially completely liquified solution; subjecting the resultant solution to a secondary fermentation with baker's yeast, optionally with an enzyme mixture similar to that for the primary fermentation, to saccharify the same into sugars: and concentrating the saccharified solution into a syrupy or solid confectionery product, optionally with sufficient sugar added to aid in solidification. Flavoring amounts of flavoring agents including fruits, vegetables, or seafood or seaweed can be added for the secondary fermentation.

This invention relates to a method of producing confectionery materials and especially from brown rice by means of complex enzyme-containing agents generated by subjecting the brown rice to the Japanese procedure for making the product known as “koji”.

### BACKGROUND

It is well known that sweetening materials can be produced from starch which is a polysaccharide. For this purpose, the starch is subjected to hydrolysis by heating a water suspension of the starch (which is not directly soluble in water) in the presence of a small amount of an inorganic acid, such as hydrochloric acid or sulfuric acid. Under such conditions, the starch breaks down into lower saccharides, initially a mixture of glucose, maltose and dextrin which is itself marketable as a sweetening agent and as household syrup. If hydrolysis is continued, possibly with added acid, conversion into glucose becomes more or less complete. By evaporation, the glucose solution can be concentrated into the form of a syrup in a first step and by further evaporation in a second step to a concentration sufficiently high that the solution solidifies when cooled, either form being useful for making table syrup and confectioneries such as candy.

The seeds of many plants contain significant amounts of starch. Corn and potatoes, both utilized as primary starch sources in the United States, respectively contain about 50 or more and about 20 percent starch. Rice contains even more, i.e. in the vicinity of about 75 percent starch. Hence, in countries where rice abounds, it represents a valuable raw material for the confectionery trade.

It is also well known that starch can be hydrolyzed into lower saccharides by enzymatic action, a conversion that plays an important role, for instance, in the brewing of beer. Here, rice is used along with sub-divided corn (“grits”) as a source of starch and in a preliminary stage, (known as “mashing”) preceding the generation of alcohol by fermentation, the starch from these raw materials is extracted and liquified and then converted into sugars by the action of diastase derived from malt. These sugars can then converted into alcohol by fermentation in the presence of yeast.

“Koji” is a product similar to yeast that has been known in Japan for nearly two millennia and is utilized in making seasonings such as soy sauce and fermented soy paste (called “miso”). It is a complex natural material resulting from the inoculation and growth on steamed white rice as a substrate by the known mold Aspergillus oryzae and contains complex protein-decomposing enzymes. It is known in the U.S.A. as a digestive agent under the name “Taka Diastase” and has been employed on an industrial scale in the processing of wheat protein.

In addition to the field of brewing, enzymatic agents such as yeast have been utilized for making confectionery products such as syrups and candy by the saccharification and fermentation of starch carbohydrates contained in raw materials such as white rice and wheat. No attempt was made to preserve any nutritious substances as might be contained in these raw materials; instead these substances were simply discarded. Yet, in some cases, nutritious substances such as vitamins and amino acid as well as flavorings and softeners were added to the final products to enhance their nutritional value.

### OBJECT OF THE INVENTION

The object of the invention is a method of producing confectionery products by the conversion of brown rice after germination into “koji” and utilizing the complex enzymes released during this conversion to effect by fermentation saccharification of the starch present in the brown rice into a sugary solution capable of concentration into syrup or solid confections (e.g. candy) while preserving into concentrated products the nutritional substances naturally present in the germinated brown rice.

### DESCRIPTION OF THE INVENTION

In accordance with the invention, brown rice is used as the essential raw material for making confectionery products. It will be understood that “brown rice” is rice in its natural state (but of nurse, after washing and like cleaning to remove soil or similar debris) including the hard outer husk or skin which when removed is known as “bran”. While the usual practice is to remove this skin to yield white, polished or milled rice, retention of the skin on the rice grains is essential to the practice of the invention. In the invention, the brown rice is not utilized directly but is first allowed to undergo germination in an oxygenated aqueous environment. Germination of the brown rice kernels enhances their nutritional content and the germinated brown rice contains valuable nutritional substances including protein, minerals and vitamins such as thiamin, riboflavin and niacin, essential amino acids such as lysine and γ-aminobutyric acid, and prolyl endopeptidase which may have medicinal value. These substances are lost (or much reduced in amount) when the husk is removed and discarded as has been the practice of the prior art.

Germination of natural grains is well known, especially in the case of wheat germ, and the germination of the brown rice does not by itself constitute a part of the novelty of this invention. However, to ensure a full disclosure, the following particulars can be given for the germination step. The brown rice grains are held within a tank maintained under aseptic conditions at about room temperature, i. e. 20-25° C., fresh water being continuously circulated within the tank with oxygen being supplied thereto in the form of minute air bubbles jetted from a nozzle at the bottom of the tank. This is continued for about 50 hours more or less while the brown rice grains absorb water, undergo cell division and germination. The germinated product can have germ buds of about 0.5-1.0 mm in size.

The germinated brown rice may then be steam-cooked in preparation for the next step. Steam-cooking, which results in softening of the grains, is carried out in the usual manner for preparing rice for human consumption and is finished when the rice is suitable for eating. The steam-cooked germinated brown alone, or more preferably in combination with steam-cooked white rice or polished wheat, subjected to the growth of a trace amount of the microorganism Aspergillus orizae, a known mold, following the known technique for producing koji. In this technique, the germinated and steam-cooked brown rice after inoculation with a minute amount of the mold is spread in a relatively thick layer. e.g. about 2 inches (5 cm) or so, covered with porous cloth to permit air circulation, and kept under a high humidity (e.g. 90%) until the microorganism grows on the layer surface like a mold or fungus. As the microorganism proliferates, it releases carbohydrate-degrading enzymes that in a subsequent stage of the present process aids in liquefying the carbohydrate content of the starch present. When the layer surface is covered with the white fungus, the koji is complete and ready to be recovered for further processing.

Because of the hard outer husk on germinated brown rice, proliferation of the aspergillus into koji does not proceed readily although it does occur and if prolongation of processing time is not a serious consideration, conversion of the germinated brown rice alone into koji is a possible way to practice the invention. However, aspergillus proliferates quite freely on the granules of steam-cooked white or polished rice or wheat and the presence of an amount of the latter in admixture with the steam-cooked germinated brown rice during the koji-forming stage is advantageous in order to accelerate the proliferation of the microorganism on the germinated brown rice granules. The amount of white rice is not critical and can be varied widely. Since the germinated brown rice is the essential component of the carbohydrate substrate, a significant amount of germinated brown rice must be provided.

Broadly speaking, the ratio of germinated brown rice to white rice and/or polished wheat can range between about 9/1 to 1/9 by weight but preferably the content of germinated brown rice should exceed 10% by weight so as to increase the contribution of the germinated brown rice to the final product. The choice of a particular ratio is basically pragmatic, balancing the amount of germinated brown rice for its content of nutritious substances against an amount of white rice and/or polished wheat consistent with good and rapid proliferation of the aspergillius on the mixture. Thus, a 50/50 mixture by weight of germinated brown and white rice has been found to achieve very efficient action by the microorganism. In particular, the higher amount of germinated brown rice results in increasing the generation of γ-amino butyric acid which is a valuable nutritious by-product.

The germinated brown rice and white rice can be mixed and steam-cooked together or they can be steam-cooked separately and then mixed for the next step.

As an alternative to the addition of the bran-free white rice or polished wheat to the germinated brown rice, the germinated and steam-cooked brown rice can be crushed to develop cracks in the outer husk or skin so that the microorganism has better access to the starchy interior of the germinated brown rice grains and can proliferate more readily. But this is usually more complicated than admixture of the white rice or polished wheat with the germinated brown rice.

After the koji has been formed by the desired degree of aspergillus development on the selected substrate, it is subjected to a stage of fermentation, referred to as “primary fermentation”. For this purpose, the kaji is suspended by mixing in enough water to form a fluid mixture commensurate with ready fermentation. The amount of water is not critical and about equal quantities of koji and water has been found satisfactory. The water should normally be boiled to avoid any contamination and cooled.

While the final koji product contains a complex mixture of enzymes released by the action of the aspergillus which exerts a decomposing action on the rice substrate, it is usually desirable, if not necessary, dependent on the conditions used for the koji production, to carry out the primary fermentation stage in the presence of minute quantities of additional enzymes sufficient in type and amount to effect substantially complete liquification of the koji during that stage. Ultimate saccharification of the carbohydrate content of the koji can be assisted by means of one or more carbohydrate-decomposing enzymes such as amylase and cellulase, the protein content (from the brown rice) requires at least one protein-decomposing enzyme, e.g. proteases such as pepsin, proteinase, and peptidase, while the lipid (fat) content calls for at least one lipid-decomposing enzyme such as lipase. The action of an individual enzyme being specific to a particular substrate (as the material attacked by an enzyme is usually referred to), optimum results are obtained with a mixture of the different types of enzymes. Other possible enzymes include cellubiose and pentinase. Obviously, the variety and amounts of the different enzymes can be determined experimentally for a given batch of koji with the aim of substantially complete liquification and any other properties desired for the treated material.

The amounts of the various enzymes used are usually quite small in the order of a few hundredths of 1%. Here again, one can resort to experimentation to ascertain what quantities work best under a given set of conditions.

If desired, the carbohydrate content of the material undergoing the primary fermentation (and thus the eventual output of the confectionery material) can be augmented by the addition of a minor amount of maltose, say of around 10% and possibly up to about 20%, which tends to promote the rate of fermentation.

The primary stage of fermentation is carried out with heating to around 50-60° C., with boiling being avoided for obvious reasons. The pH should be in the vicinity of neutrality, say pH 5-8, while the duration of the primary stage can range from 15 to 50 hours or as needed for substantially complete liquification to take place.

Upon completion of primary fermentation stage, the resultant substantially completely liquified solution is subjected to a “secondary fermentation stage” by means of a small quantity of baker's yeast and possibly other enzymes such as those employed for the primary stage. During secondary fermentation, the temperature of the solution can be slightly lower than that of the primary stage, e.g. in the range of about 40-50° C., but this is not critical and can be varied. The pH remains about the same as during the primary stage, e. g. about pH 5-8, and the duration of the secondary fermentation may be somewhat longer, e.g. about 2-5 days, or until maximum saccharification is achieved. By saccharification is meant the conversion of virtually all of the starchy components of the koji into the sweet sugars needed for a confectionery product. Mild or gentle stirring of the solution is useful for uniform reaction as is also true for the primary stage.

An important benefit results if in addition to the baker's yeast, a small amount of a mixture of exogenous enzymes similar to that utilized for the primary fermentation is added at the beginning of the secondary fermentation. Although the product of the primary fermentation stage is virtually completely liquified as a consequence of the enzyme action during that stage, decomposition during the secondary fermentation of the components of the first stage product into lower molecular structures can be promoted and extended by the further action of the enzymes.

As a simple illustration of the effect of secondary fermentation, the decomposition sequence for proteins is as follows: Protein→peptide→amino acids.

Amino acids are of course desirable from a nutritional standpoint. In the case of lipids, further decomposition can result in the generation of esters which improve the flavor and fragrance of the products. In general, the degree of flavor development corresponds with the amount of the added enzyme mixture employed.

The confectionery solution resulting from the secondary stage is concentrated by heating at a temperature which would normally be below the boiling point in order to preserve to desirable consitutents of that solution and preferably under reduced pressure in a vacuum pan or the like to reach the sugar content sought for dependent upon the intended ultimate state of the product, i.e. as a syrupy liquid or as a solid at room temperature.

The option exists for imparting during the secondary stage of fermentation to the confectionery product some particular flavor or taste. To this end, suitable amounts of distinctively flavored edible substances such as brown sugar, fruits, vegetables, or even seafood products. As examples to illustrate the variety of possible flavoring materials, one might list grapes, oranges, pineapples, Chinese cabbage, green cabbages, Japanese leeks, kelp or fish, alone or in appealing combinations. The quantity of such materials that can be added cannot be identified with any degree of certainty given the wide range of materials and the differences in the intensity of their taste or smell and also the form in which they are added, i.e. as the juice or extract or as sub-divided solids. In the latter case, any solid residue can be removed by filtering if deemed objectionable. As an illustration, equal amounts of the solution of the primary stage of fermentation and fruit juices or seaweed extracts have been combined for the secondary stage to obtain attractively-flavored products.

### EXAMPLES

### Example 1

20.0 kg each of white rice and polished wheat are steam-cooked in the usual way and after cooling are mixed with 20.2 kg of steam-cooked brown rice that has been allowed to undergo germination under aseptic conditions as described previously. The mixture is then innoculated with 4.0 kg of Aspergillus oryzae for making koji and then processed in the usual way, as described above, to make 54.0 kg of koji mixture.

The resultant koji is pulverized and subjected to a primary fermentation stage. In the primary stage, the koji is admixed in a tank by stirring with 54.0 kg boiled and cooled water, 5.4 kg of maltose, and 0.023 kg of an enzyme mixture comprising about equal proportions of amylase, protease, and lipase and allowed to ferment for about 24 hours at 55° C. Inspection of the fermented mixture revealed that it had become substantially completely liquified.

The substantially liquified product of the primary fermentation stage is then subjected to a secondary fermentation stage. For the latter, the product is mixed with 11.3 kg of maltose, 0.113 kg of baker's yeast, and a mixture in approximately equal proportions of the enzymes amylase, protease, and lipase and while maintained in the tank at about 40-50° C. with gentle stirring allowed to undergo fermentation for 2 days.

The resultant doubly-fermented material is then concentrated by introduction into a vacuum pan and heated at 70° C. under a reduced pressure of 600 mmHg for a time sufficient to reach a solids content of 75% giving a weight of syrupy confectionary (sweet) product of 74.9 kg.

### Example 2

Example 1 was repeated except that at the beginning of the secondary fermentation stage, 87.4 kg of crushed grapes was added to the liquified product from the first stage along with the other ingredients for the second stage. There was obtained an excellent sweet syrupy product exhibiting a fine grape flavor.

### Example 3

Example 1 was repeated except that for the secondary fermentation stage, 99.8 kg of crushed grapes, 99.8 kg of crushed oranges and 99.8 kg. of crushed pineapple were added to the liquified product from the first stage along with the other ingredients for the second stage. There was obtained an excellent sweet syrupy product having an appealing mixed fruit flavor.

### Example 4

A sensory test was performed on the products of the above Examples 1 and 3. For this test, a panel of six men of 40-60 years in age and six women of 25-50 years in age were requested to consume samples of the respective products and provide an evaluation of the same with respect to the properties of odor, body, flavor, aftertaste, and overall value in comparison with a conventional confectionary syrup, ranking each of the products as either “good” or “poor”. The number of individuals giving the ranking for each property are tabulated below according to gender.

TABLE 1
Unflavored Starch Syrup of Example 1.

| ITEM | | ODOR | | BODY | | FLAVOR | | AFTERTASTE | | OVERALL VALUE | |
|---|---|---|---|---|---|---|---|---|---|---|---|
| ITEM | COMPARISON | M | F | M | F | M | F | M | F | M | F |
| CONVEN. | GOOD | 1 | 2 | O | 2 | 1 | 1 | 2 | 1 | 1.0 | 1.5 |
| PRODUCT | POOR | 5 | 4 | 6 | 4 | 5 | 5 | 4 | 5 | 5.0 | 4.5 |
| INVENTIVE | GOOD | 5 | 5 | 4 | 4 | 5 | 5 | 4 | 5 | 4.5 | 4.5 |
| PRODUCT | POOR | 1 | 1 | 2 | 2 | 1 | 2 | 2 | 1 | 1.5 | 1.5 |

TABLE 2
Solid candy made from a mixture of equal amounts of mixed
fruit flavored starch syrup of Example 3 and sugar.

| ITEM | | ODOR | | BODY | | FLAVOR | | AFTERTASTE | | OVERALL VALUE | |
|---|---|---|---|---|---|---|---|---|---|---|---|
| ITEM | COMPARISON | M | F | M | F | M | F | M | F | M | F |
| CONVEN. | GOOD | 2 | 3 | O | 1 | 1 | 1 | 4 | 3 | 1.8 | 2 |
| PRODUCT | POOR | 4 | 3 | 6 | 5 | 5 | 5 | 2 | 3 | 4.2 | 4 |
| INVENTIVE | GOOD | 4 | 4 | 5 | 4 | 5 | 5 | 5 | 4 | 4.5 | 4.5 |
| PRODUCT | POOR | 2 | 2 | 1 | 2 | 1 | 1 | 1 | 2 | 1.5 | 1.5 |

It will be seen from the tabulated results that the products of the invention whether in syrup or solid candy form were adjudged by the participants in the tests to be superior in all respects measured to corresponding conventional products. Thus, the invention makes possible the creation of novel confectionery products, such as candies, preserving the valuable nutritional components of germinated brown rice without loss in its desirable properties and also achieves an advance in the art of candy-making by fermentation using a variety of natural food materials such as fruit, vegetables, sea products and the like.

In the course of the preceding description, reference has been made to a number of alternatives or variations in the practice of the invention and others undoubtedly apparent to one skilled in the present art. It is intended that all such modifications are within the scope of the invention except as positively excluded from the ambit of the appended claims.

That which is claimed is:

1. A method of making a confectionery product by fermentation of starch derived essentially from germinated brown rice containing natural nutritious substances which comprises the steps of:
a. Allowing brown rice to undergo germination and steam-cooking the same;
b. Inoculating a starchy substrate consisting essentially of the steam-cooked germinated brown rice of step a. with a koji-forming amount of the mold Aspergillus oryzae and allowing the mold to proliferate on the substrate until koji is formed;
c. Recovering the koji of step b. and subjecting the same in suspension in cooled boiled water to a primary anaerobic fermentation in the presence of enzymes sufficient in type and amount to substantially completely liquify the entirety of said koji;
d. Subjecting the substantially completely liquified koji to a secondary fermentation in the presence of enzymes consisting essentially of baker's yeast for a time sufficient to substantially completely saccharify the same; and
e. Removing sufficient water from the saccharif ied material of step d. to concentrate the same into a confectionery product.

2. The method of claim 1 wherein said starchy substrate of step b comprises in addition to said steam-cooked germinated brown rice steam-cooked bran-free natural grain.

3. The method of claim 2 wherein said steam-cooked bran-free natural grain is selected from the group consisting of steam-cooked white rice and steam-cooked polished wheat.

4. The method of claim 2 wherein said germinated brown rice and said bran-free grain are separately steam-cooked and mixed in amounts in the range of 9/1 to 1/9 by weight.

5. The method of claim 2 wherein germinated brown rice and bran-free natural grain are mixed in amounts in the range of 9/1 to 1/9 by weight and steam-cooked together.

6. The method of claim 1 wherein the enzymes present during said primary fermentation comprise small amounts of each of a carbohydrate-decomposing enzyme, a protein-decomposing enzyme and a lipid-decomposing enzyme whereby essentially the entirety of the components of said koji are substantially completely liquified.

7. The method of claim 1 wherein a minor amount of maltose is added to said koji for said primary fermentation.

8. The method of claim 1 wherein a flavoring amount of a flavoring agent is added to said completely liquified koji for said secondary fermentation.

9. The method of claim 8 wherein said flavoring agent is selected from the group consisting of fruits, vegetables, or seafood and seaweed all in sub-divided form.

10. The method of claim 9 wherein any solid particles from said flavoring agent are separated from the product of step d. before concentration of the same.

11. The method of claim 1 wherein said brown rice is germinated by agitating the rice is an aseptic aqueous environment with the continuous introduction of oxygen for a time sufficient to form germ buds of about 0.5-1 mm in size.

12. The method of claim 1 wherein the enzymes present for the secondary fermentation of step d. comprise in addition to said baker's yeast small amounts of each of a carbohydrate-decomposing enzyme, a protein-decomposing enzyme and a lipid-decomposing enzyme.
